(19) United States
(12) Patent Application Publication
(10) Pub. No.: US 2002/0130242 A1
(43) Pub. Date: Sep. 19, 2002

(54) Christmas tree stand

(76) Inventor: Martin Thurner, Strasskirchen (DE)

Correspondence Address: JORDAN AND HAMBURG LLP, 122 EAST 42ND STREET, SUITE 4000, NEW YORK, NY, 10168, US

(21) Appl. No.: 10/017,054

(22) Filed: Dec. 14, 2001

(30) Foreign Application Priority Data
Jan. 12, 2001 (DE) 101 01 312.4

(51) Int. Cl. F16M 13/00

(52) U.S. Cl. 248/523; 248/519

(57) ABSTRACT

The invention relates to a stand for holding bar-like components (2), especially on Christmas trees, having a socket element (3) and a clamping and holding system (4), a centering system (8) being provided for centering the bar-like component (2), having at least one flexible element (9), which reaches radially into a socket opening (10) of the socket element (3) so that a centering action with respect to a center point of the stand is produced on the bar-like component (2) when introduced into the socket element (3).

The invention relates to a stand for clamping bar-like components, especially trunks of Christmas trees.

In the state of the art, a number of stands for holding Christmas trees are known, which are equipped with various kinds of devices for supporting or holding Christmas trees upright. Many such devices are complicated to operate or do not give the tree the necessary support, so that the Christmas tree does not remain in the vertical position desired by the user.

An especially user-friendly clamping and holding device for Christmas tree stands is known, in which pivotably mounted holding elements in the form of claws cooperate with a force-applying element in the form of a steel rope. The force-applying element is operated by means of a clamping device in the form of a releasable ratchet wheel system for tightening the holding elements. This form of clamping and holding device is very easy and safe for a user to operate. The clamping device for engaging the holding elements through the force-applying element moves the holding elements into the holding position with a defined holding force and, by means of the force-applying element, all the holding elements can be moved freely toward the Christmas tree trunk until all of the holding elements are in contact there and then they are forced with a substantially equal holding force against the Christmas tree trunk.

However, there is the problem that, especially in the case of small trees or thin tree trunks, vertical clamping is difficult, since the holding elements do not engage the trunk until after a certain period and, for as long as the tree is unguided, that is, is loose in the socket element of the stand, it can easily slip. If the trunk is not precisely in the center, the holding elements cannot uniformly engage, and there is the danger that the tree will not be gripped by all holding elements and thus it may be held with a tilt or insufficiently gripped.

Therefore, the present invention is addressed to the problem of creating a stand for holding bar-like components upright, especially those of Christmas trees and a centering system for such stands, in which the bar-like component is correctly positioned within the socket even before it is clamped and, by means of which bar-like components of especially small diameter, can be clamped easily and in an upright position.

The problem of the present invention is solved by stands for holding bar-like components with the features according to claim 1 and by a centering system with the features pursuant to claim 14. Appropriate embodiments are defined in the particular dependent claims.

According to the invention, a stand for clamping bar-like components, especially of Christmas trees, has a socket element and a clamping and holding system. The socket element has a centering device for centering the bar-like component, at least one flexible element being provided, which extends radially into an opening in the socket element so that, in cooperation with the flexible element, a centering action with respect to the center point of the stand is produced on the bar-like component when it is introduced into the socket. Thus, even components with very small diameters are guided always toward the center of the stand even before the actual holding system engages the component and clutches it to stand it up. This prevents especially Christmas tree trunks of small diameter from being set away from the center of the stand so that the holding system would consequently hold the tree trunk up incorrectly or at an undesired point. The bar-like component is guided into the desired position just as it is introduced into the socket element.

According to an advantageous embodiment of the invention, the flexible element is so configured that it makes contact at least area-wise with the periphery of the bar-like component and, upon the introduction of the component (the trunk), it is displaced by the component. Flexural forces are thus produced toward the center of the stand and the component is guided very simply by the counterforces toward the center (for example, a centering spur in the interior of the stand) and also Christmas tree trunks are clamped in the desired position in the stand even in the case of very thin trunk diameters. It is another advantage that, even in the case of thicker trunks (thick in comparison to the diameter of the socket opening), the trunk will descend all the way into the bottom of the socket opening. By this complete lowering of the trunk, for example, onto a centering spur, the distance from the bottom end of the trunk to the point of engagement of holding elements of the holding system of the stand is increased. In this manner, trunks are held in place substantially better. In case the stand is also filled with water, it has the advantages that the trunk remains always held sufficiently deep in the water and that, on account of the covering effect of the centering element, less water can evaporate, so that most of the water that is present is available to the tree for absorption.

According to another advantageous embodiment of the invention, the flexible element can be moved in the horizontal plane or can be moved horizontally and vertically. In the case of a horizontally movable element the stand can be made especially low.

According to another advantageous embodiment of the invention, a plurality of centering claws is provided, which are movably biased by joints and springs so that, upon the insertion of the component, they are shifted away thereby. This prevents the centering element from losing its functionality after a certain period, for example, due to material fatigue. According to an alternative configuration in this regard, the flexible element is a flexible centering sleeve, which is made in one or more parts. In this manner, a cone-shaped centering surface is formed upon the insertion of the component and centers it by clutching it toward the center point of the stand.

In another advantageous embodiment of the invention, the centering system has a ring whose outside circumference corresponds essentially to the outside circumference of the socket element, and tongue-like sections arranged on the inside circumference of the ring are provided as centering elements. These tongue-like sections can be spaced apart or be made to overlap one another. The centering system is thus created by a low-cost element of simple design. The thinning of the material at the bridges assures the flexibility of the flexible elements, which can be adapted accordingly by appropriate choice of material (one-piece plastic, variously combined plastics, etc.). The flexible elements are resiliently joined through the bridge to the ring of the centering device. This has the advantage that, whenever bar-like components whose diameter is greater than that of the opening defined by the flexible elements, the flexible elements yield and are forced downwardly, so that the opening expands. The tongue-like configuration of the elements also makes it possible for the holding elements of the holding system of the stand (such as pivoting claws) to be arranged between the flexible elements and their operation is not impaired.

As fastening devices for fastening the centering system to the socket of the stand, through-bores are preferably provided on the ring, especially four through-bores arranged at equal intervals. Alternatively, however, the ring can also be joined by a clip to the housing or the socket element of the stand or by any other known fastening means.

In an advantageous embodiment of the inventive stand, the ring, the bridge and the flexible elements are made integral with one another. Advantageously, the centering system is then made of plastic, which can be formed simply by the known manufacturing processes, for example, the two-component technology.

In an additional preferred embodiment of the invention, the flexible elements are made in the manner of ring segments or segments of a circle. In this way, the socket opening is substantially covered up except for a central opening for the introduction of the component or trunk, thereby preventing a component from being inserted laterally into the socket opening and thus, under certain conditions, fail to be clutched at all by the holding elements. The flexible elements can in that case be spaced apart or overlap one another.

The inventive stand serves for the vertical clutching of a bar-like component or a portion with at least one substantially bar-like section, such as, for example, sunshades, flagstaffs, traffic signs, but chiefly Christmas trees. The combination of the clamping and holding system and the centering system offers an optimum base for a bar-like component placed in the stand, even if the bar-like component has but a small diameter. Furthermore, by providing the centering on the stand, the clamping of a bar-like component is even easier for the user. The opening defined by the flexible elements of the centering system establishes the position, at which the bar-like component is to be inserted, and additionally provides a preliminary setting for it. Since the elements are flexible, bar-like components of many different diameters can be inserted into the stand because, when bar-like components of a larger diameter than the opening defined by the flexible elements are inserted into the stand, the flexible elements yield and bend downwardly, so that the opening expands. The centering system furthermore offers a preliminary hold for a bar-like component just being set into the stand, before the clamping and holding system has been actuated. When the clamping and holding system has then been brought into the closed position for holding the bar-like component, it and the centering system work together in an optimum manner in order thus to hold even especially thin Christmas tree trunks securely in a vertical position.

According to an additional advantageous embodiment of the invention, the holding elements and the flexible elements are offset radially from one another.

Preferably, the centering system is made of plastic, although other materials are also possible. The centering system can also be made integral with the socket element. However, it can also be a separate element, which is advantageous in case old stands are to be equipped with a centering system. Then it has fastening means, especially holes, so that they can be fastened on the socket element or be bolted to it.

According to another advantageous embodiment of the invention, the clamping and holding system is provided with at least one force-applying element cooperating with holding elements. The holding elements are mounted for pivoting between an open position to receive the bar-like component and a closed position to hold the bar-like component. At least one wire rope can be provided, for example, as the force-applying element, which passes over pulleys and exerts a turning/tightening movement on the vertically pivoting holding elements.

According to the invention, the centering system for stands for clamping bar-like components has at least one flexible element, which reaches radially into a socket opening of a stand so that, in cooperation with the element, it produces a centering action on a bar-like component received into the socket element, with reference to a center point on the stand. Due to this centering element, not only can especially thin bar-like components be better inserted into a stand and be received and supported therein but, due to the flexibility of the element, even bar-like components of larger diameter than that of the opening defined by the centering element can be received and supported therein. Preferably, the centering element is a flexible element, which engages area-wise the circumference of the component and, by flexing downwardly in the direction of the center point of the stand, produces flexural and retention forces, which urge the component into a center. Thus, an effective centering is assured by a simple design.

The invention is explained hereinbelow by an embodiment, with the aid of the appended drawings.

In the drawings:

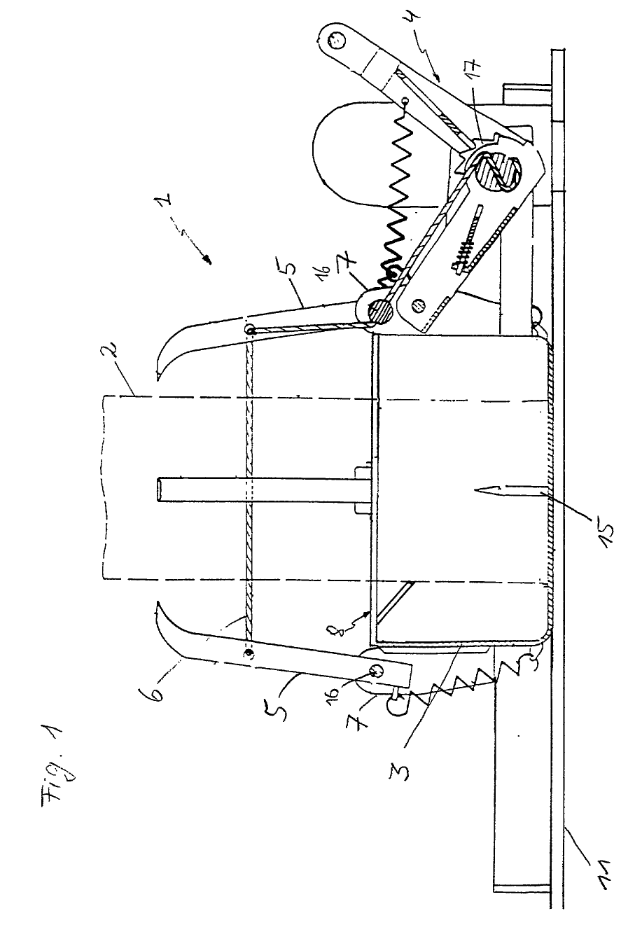

FIG. 1 shows a cross section through a clamping module of the inventive stand,

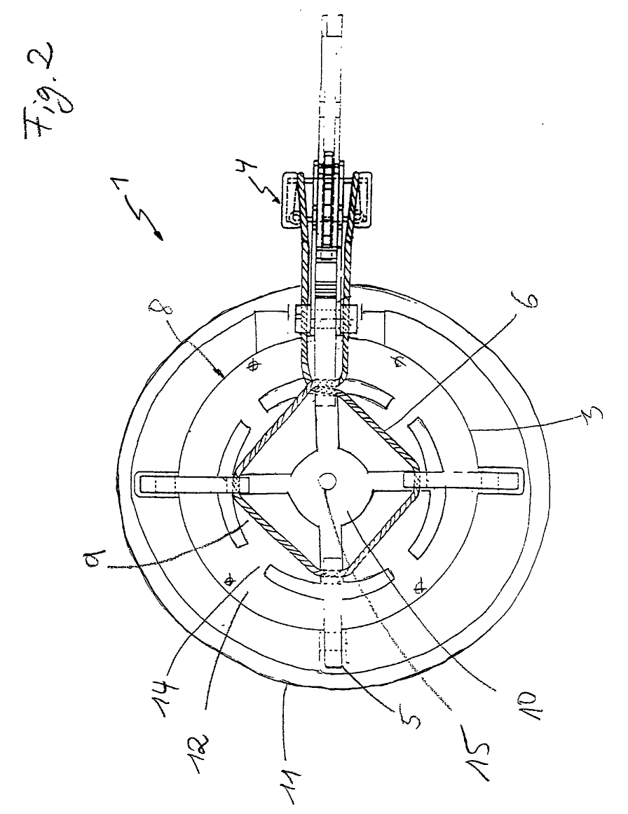

FIG. 2 shows a plan view of the clamping module of the inventive stand,

FIG. 3 shows a plan view of a centering system disposed on the bottom of a housing,

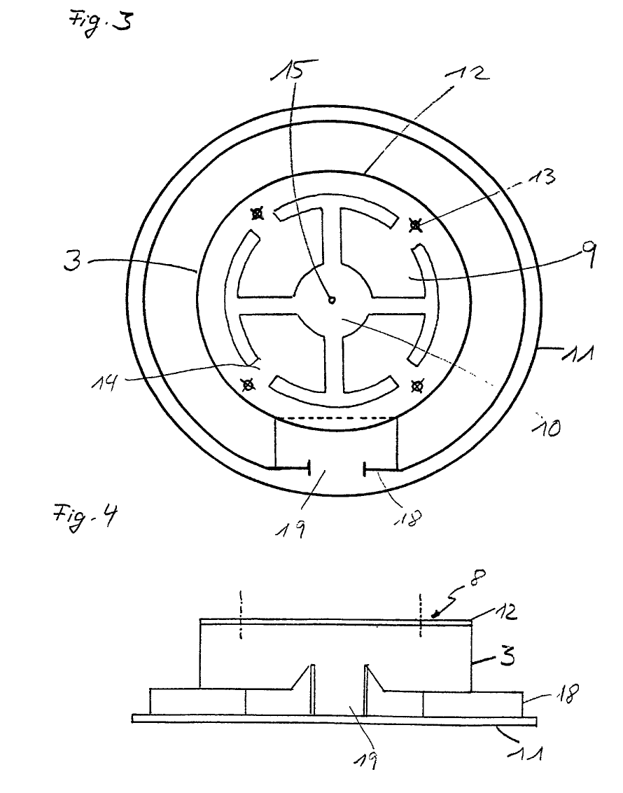

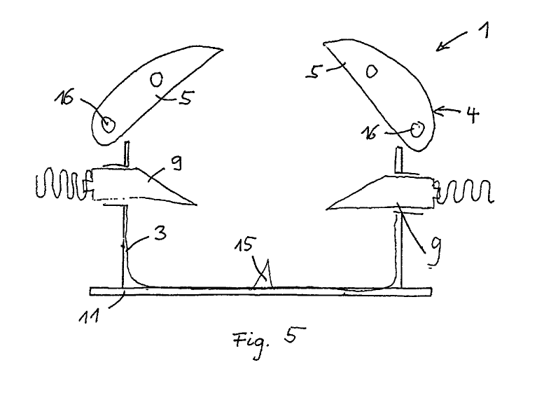

FIG. 4 shows a side elevation of the centering system shown in FIG. 3 and disposed on the bottom of a housing,

FIG. 5 shows a schematic representation in a side elevation of a stand with horizontally movable centering elements of the inventive centering system.

In FIG. 2, there is shown a cross-sectional view of a clamping module of the inventive stand. The clamping module 1 has a socket element 3, into which the bar-like component 2 is inserted. In the center of the bottom of the socket element 3, a spur 16 is provided, onto which the bar-like component 2 is placed. Alternatively to the spur 15, a plurality of spurs can also be provided, or a rough surface. In the latter case, the centering system 8 largely replaces the function of the spur 15. The socket element 3 is disposed in the center of the housing bottom 11. The housing of the stand comprises, in addition to the bottom 11, a housing cover, which can be placed thereon and which is not represented. On the outer circumference of the socket element 3, four supporting elements 7 are uniformly spaced apart from one another around the circumference. The supporting elements 7 are each articulately joined through pivot axes 16 to holding elements 5, so that the holding elements 5 can be turned from an open position to a closed position, in which they are in engagement with the bar-like component 2. A clamping and holding system 4 comprises a ratchet wheel 17, the force-applying element 6 in the form of a steel rope connected to the ratchet wheel 17, and the holding elements 5 configured as claws and connected with the force-applying element 6. Upon the actuation of the clamping system 4, the holding elements 5 move uniformly and with no substantial force against the outer contour of the bar-like component 2 that is to be clamped, until all of the holding elements 5 make contact with its surface and the bar-like component 2 is thus fixed in a vertical position in the stand. Additional fixation of the bar-like component 2, especially one of small diameter, is offered by the centering system 8. The centering system 8 is placed upon the socket element 3. Four flexible elements 9 of the centering system 8 reach radially into the opening of the socket element 3 and define it. If, as in the case here represented, the diameter of the bar-like component 2 is greater than the opening defined by the flexible elements 9, the flexible elements 9 flex downward in order to free an expanded opening space corresponding to the diameter of the bar-like component 2. Thus, the bar-like component 2 is offered additional support, which acts even before the clamping system 4 is operated for the purpose of driving the holding elements into the closed position.

FIG. 2 shows a top plan view of the clamping module represented in FIG. 1. The socket element 3 is disposed centrally on the housing bottom 11. The centering system 8 is fastened on the socket element 3 by means of screws, which are driven through holes 13 in a ring 12 of the centering system 8. Alternatively, the ring 12 can also be fastened to the housing or socket element 3 of the standby a clip fastening or the like. The simplified assembly of the parts speeds manufacture and reduces the number of parts. The ring 12 has four bridges 14 that are formed on it and spaced uniformly apart from one another. A flexible element 9 of ring segment-like shape is formed on each of the bridges 14. The flexible elements 9 define a central and expandable socket opening 10, into which the bar-like component 2 can be inserted. The ring 12, the bridges 14 and the flexible elements 9 are made integral with one another and made of plastic. Their flexibility can be determined by the choice of the plastic together with their bridge-like taper so that the ring is nevertheless sufficiently stiff. Alternatively, different kinds of plastic can also be used, which are formed one on the other or they can be manufactured advantageously by the two-component technology.

The flexible elements 9 are spaced equally apart. At the spaces, that is, about 45° offset from the positions of the bridges 14 of the flexible elements 9, the holding elements 5 are disposed on the socket element 3 which, by means of the clamping system 4, can be operated through the force-applying element 6. According to another embodiment (not represented in the drawing), the holding elements 5 are so arranged that, when they are in a fully closed position, they are lowered almost entirely below the ring 12 in the interior of the stand. This has the advantage of a compact shape for packaging for shipment and sale.

In FIG. 3, there is shown a top plan view of the centering system 8 without the tightening system 4, which is disposed on the socket element 3, which again is situated centrally on the housing bottom 11. The housing bottom 11 is made integral with the socket element 3. Also, a substantially circumferential wall 18 is provided on the housing bottom 11 and is likewise integral with the housing bottom 11 and has an opening 19 at the position, at which the ratchet wheel 17 (not shown in the drawing) of the clamping system 4 is to be provided. The centering system 8 comprises a ring 12 with four holes 14 for fastening or bolting the centering system 8 onto the socket element 3. As also in FIG. 2, four flexible ring segment-like flexible elements 9 are resiliently joined by bridges 14 to the ring 12, so that the socket opening 10 defined by the flexible elements 9 can be expanded.

FIG. 4 shows a side view of the centering system 8 represented in FIG. 3, with the housing bottom 11 and socket element 3. The substantially circumferential wall 18 formed integrally with the housing bottom 11 is formed with an opening 19 at the position provided for the ratchet wheel 17 (not shown in the drawing). The circumference of the centering system is equal to the circumference of the socket element 3.

In FIG. 5, a second embodiment of the invention is shown schematically in a side view. The flexible elements 9 are wedge-shaped sliders which, being driven radially and by springs, extend into the socket space of the socket element 3. The flexible elements 9 can be driven only horizontally in this embodiment.

1. A stand for holding bar-like components (2) upright, especially those of Christmas trees, with a socket element (3) and a clamping and holding system (4), wherein the socket element (3) is provided with a centering system (8) for centering the bar-like component (2), the centering system (8) having at least one flexible element (9), which reaches radially into a socket opening (10) of the socket element (3) so that, in cooperation with the element (9), a centering action with respect to a center point of the stand is produced on the bar-like component (2) upon insertion into the socket element (3).

2. The stand of claim 1, wherein the flexible element (9) upon the introduction comes in contact at least area-wise with the circumference of the bar-like component (2) so that it is displaced by the component (2).

3. The stand of claim 1 or 2, wherein the flexible element (9) is movable in the horizontal plane.

4. The stand of claim 1 or 2, wherein the flexible element (9) is movable horizontally and vertically.

5. The stand of claim 2, wherein a plurality of centering flaps is provided, which are biased through joints and springs so that they are pushed away by the component (2) upon insertion.

6. The stand of claim 2, wherein a flexible centering sleeve is provided as the flexible element (9) which, due to the inserted bar-like component (2) and a resultant deflecting movement of the sleeve, forms a cone-shaped surface, which centers the component (2) with respect to the center point of the stand.

7. The stand of claim 2, wherein a plurality of tongue-like sections is provided on the inside circumference of a ring (12), which are disposed resiliently on the ring (13) through bridges (14).

8. The stand of claim 7, wherein the ring (12) has substantially the same outside circumference as the socket element (3), and that fastening means (13) are provided for fastening the centering system (8) on the socket element (3).

9. The stand of claim 7 or 8, wherein the ring (12), the bridges (14) and the flexible elements (9 are made integral with one another.

10. The stand of either of claims 7 to 8, wherein the flexible elements (9) are configured in a ring segment-like manner.

11. The stand of claim 7, wherein the centering system (8) substantially covers the socket opening (10).

12. The stand of one of the preceding claims, wherein the centering system (8) is made integral with the socket element (3).

13. The stand of one of the preceding claims, wherein the centering system (8) is made integral with a housing of the stand.

14. The stand of one of the preceding claims, wherein the clamping and holding system (4) has at least one force-applying element (6) cooperating with holding elements (5) and the holding elements (5) are journaled for pivoting between an opened position (receiving position) for receiving the bar-like component (2) and a closed position (holding position) for holding the bar-like component (2), wherein the flexible elements (9) and the holding elements (5) are disposed radially offset from one another.

15. The centering system (8) for stands for holding bar-like components (2) upright, wherein at least one flexible element (9) is provided, which reaches radially into a socket opening (10) of the stand so that, in cooperation with the element (9), a centering action with respect to a center point of the stand is produced on the bar-like component upon introduction into the stand.

16. The centering system (8) of claim 15, wherein the flexible element (9) engages at least area-wise the periphery of the bar-like component (2) so that it is displaced by the component (2) upon its introduction.

17. The centering system (8) of claim 15 or 16, wherein the flexible element (9) is movable in the horizontal plane.

18. The centering system (8) of one of the claims 15 to 17, wherein a ring (12) is provided and a plurality of tongue-like sections is disposed resiliently on bridges (14) on the ring (12).
